(19) United States
(12) Patent Application Publication
(10) Pub. No.: US 2025/0314115 A1
(43) Pub. Date: Oct. 9, 2025

(54) WINDOW REGULATOR

(71) Applicant: AISIN CORPORATION, Kariya, Aichi (JP)

(72) Inventors: Kenji YAMAMOTO, FUJISAWA-SHI (JP); Masanao BABA, FUJISAWA-SHI (JP); Satoshi ISAZAWA, FUJISAWA-SHI (JP)

(73) Assignee: AISIN CORPORATION, Kariya, Aichi (JP)

(21) Appl. No.: 18/860,934

(22) PCT Filed: Aug. 14, 2023
(86) PCT No.: PCT/JP2023/029425

§ 371 Date: Oct. 28, 2024

(30) Foreign Application Priority Data
Sep. 2, 2022 (JP) 2022-139936
Sep. 2, 2022 (JP) 2022-139937
Oct. 21, 2022 (JP) 2022-168910

(51) Int. Cl. E05F 15/689

(52) U.S. Cl. CPC E05F 15/6903; E05Y 2201/71; E05Y 2900/55

(57) ABSTRACT

A window regulator includes a bracket on which window glass is to be supported, a first arm with one end rotatably supported by vehicle member constituting door and the other end rotatably supported by bracket, a second arm with one end rotatably supported by the vehicle member and the other end rotatably supported by the bracket, and a drive member configured to drive the bracket, on which window glass is supported, by rotationally driving the first and second arms. A rotation center shaft of one end of first arm and a rotation center shaft of one end of second arm are shifted in drive direction of bracket on which window glass is to be supported. A rotation center shaft of other end of first arm and a rotation center shaft of other end of second arm are shifted in drive direction of bracket on which window glass is supported.

### TECHNICAL FIELD

This disclosure relates to a window regulator.

### BACKGROUND ART

JP 06-26264A (Reference 1) discloses an arm type window regulator device that lifts and lowers window glass of an automobile. In this window regulator device, a door inner panel is disposed inward of a door outer panel of a vehicle body in a vehicle width direction, and a side beam is disposed between the door outer panel and the door inner panel along a front-rear direction of the vehicle body on the door outer panel. Guide rails for transferring the window glass are provided between the door outer panel and the door inner panel along the front-rear direction of the vehicle body, and a link is provided that is engaged so as to be movable along a longitudinal direction in the guide rails. The link is movably engaged with each of the guide rails, and a base plate is disposed at the door inner panel. A main arm is swingably provided at the base plate, and a sub-arm parallel to the main arm is swingably provided at the side beam. A tip end portion of the main arm is rotatably coupled to the link, and a tip end portion of the sub-arm is rotatably coupled to the link.

### CITATION LIST

### Patent Literature

PTL 1: JP 06-26264A (Reference 1)

### SUMMARY OF DISCLOSURE

### Technical Problem

However, in the window regulator device disclosed in Reference 1, there is a problem that a large force (a force to cause deformation) is applied to the main arm and the sub-arm when the main arm and the sub-arm are rotated, particularly when the main arm and the sub-arm overlap each other as viewed from a pivot shaft direction of the main arm and the sub-arm.

This disclosure has been made in view of the above circumstances, and an object thereof is to provide a window regulator capable of preventing a large force from being applied to an arm member.

### Solution to Problem

A window regulator according to an embodiment includes: a bracket on which window glass is to be supported; a first arm one end of which is rotatably supported by a vehicle member constituting a door and the other end of which is rotatably supported by the bracket; a second arm one end of which is rotatably supported by the vehicle member and the other end of which is rotatably supported by the bracket; and a drive member configured to drive the bracket, on which the window glass is to be supported, by rotationally driving the first arm and the second arm. A rotation center shaft of the one end of the first arm and a rotation center shaft of the one end of the second arm are shifted in a drive direction of the bracket on which the window glass is to be supported. A rotation center shaft of the other end of the first arm and a rotation center shaft of the other end of the second arm are shifted in the drive direction of the bracket on which the window glass is to be supported.

### Advantageous Effects of Disclosure

According to this disclosure, it is possible to provide a window regulator in which rotation center shafts of a first arm and a second arm are shifted in a drive direction of a bracket so that the first arm and the second arm do not overlap each other and a large force can be prevented from being applied to the arm members.

### BRIEF DESCRIPTION OF DRAWINGS

FIG. 1 is a view illustrating a full-opening position, a full-closing position, and an intermediate position of a window regulator as viewed in a vehicle width direction;

FIG. 2 is an exploded perspective view of components of the window regulator;

FIG. 3 is a view illustrating the full-closing position of the window regulator as viewed in the vehicle width direction;

FIGS. 4A, 4B, and 4C are cross-sectional views taken along lines 4A-4A, 4B-4B, and 4C-4C in FIG. 3;

FIG. 5 is an enlarged view illustrating a single structure of a base;

FIGS. 6A, 6B, 6C, 6D, and 6E are cross-sectional views taken along lines 6A-6A, 6B-6B, 6C-6C, 6D-6D, and 6E-6E in FIG. 5;

FIG. 7A is an enlarged view illustrating a single structure of a first arm, and FIG. 7B is a cross-sectional view taken along a line 7B-7B in FIG. 7A;

FIG. 8A is an enlarged view illustrating a single structure of a second arm, and FIG. 8B is a cross-sectional view taken along a line 8B-8B in FIG. 8A;

FIG. 9A is an enlarged view illustrating a single structure of a bell crank, FIG. 9B is a cross-sectional view taken along a line 9B-9B in FIG. 9A, and FIG. 9C is a cross-sectional view taken along a line 9C-9C in FIG. 9A;

FIG. 10 is a view illustrating the window regulator as viewed in an up-down direction;

FIG. 11 is a view illustrating a full-opening position of a window regulator according to another embodiment as viewed in a vehicle width direction;

FIG. 12 is a view illustrating an intermediate position of the window regulator according to another embodiment as viewed in the vehicle width direction;

FIG. 13 is a view illustrating a full-closing position of the window regulator according to another embodiment as viewed in the vehicle width direction;

FIGS. 14A and 14B are enlarged views illustrating a single structure of a bell crank;

FIG. 15 is an enlarged view illustrating a single structure of a first arm;

FIG. 16 is a cross-sectional view taken along lines 16A, 16B, and 16C in FIG. 15; and

FIGS. 17A, 17B, and 17C are views illustrating a window regulator according to still another embodiment.

### DESCRIPTION OF EMBODIMENTS

The term “window regulator” as defined in the claims is used to refer to both a window regulator installed in an automobile (vehicle) and a window regulator in its assembly (sub-assembly) state prior to installation in an automobile (vehicle) (both fall within the technical scope of the patented disclosure). Further, “rotation” and “pivot” may be replaced with each other (may be synonymous). Further, a “rotation support portion (pivot support portion)” and a “rotation center shaft (pivot center shaft)” may be replaced with each other (may be synonymous). For example, a rotation center (pivot center) of the rotation support portion (pivot support portion) may be referred to as a rotation center shaft (pivot center shaft).

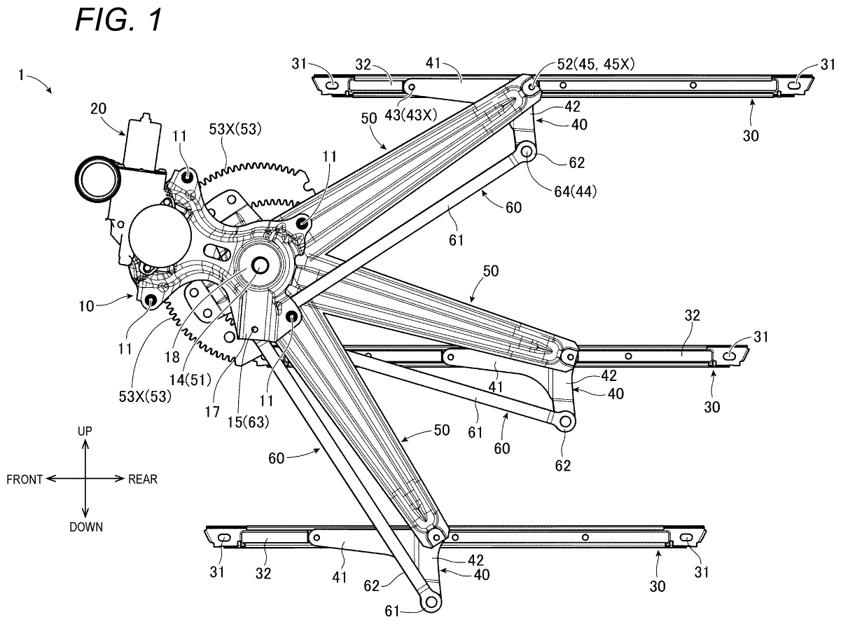

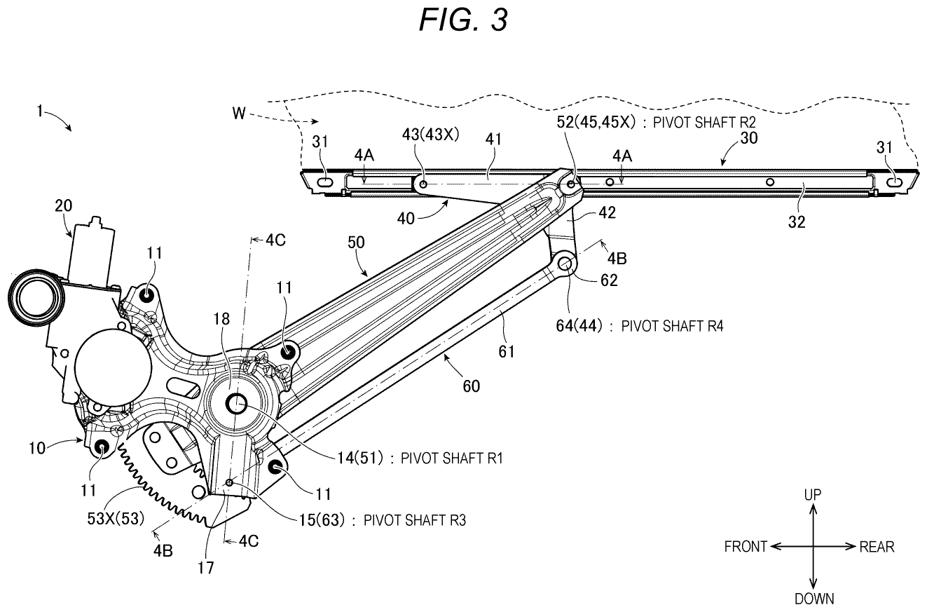

A window regulator 1 according to the embodiment will be described in detail with reference to FIGS. 1 to 10. An up-down direction, a front-rear direction, and a vehicle width direction (a vehicle interior-exterior direction) used below will be described with reference to directions of arrows in the drawings. For example, FIGS. 1 and 3 are views seen from a vehicle interior side in the vehicle width direction (a front side of the paper surface is the vehicle interior side, and a back side of the paper surface is a vehicle exterior side). Further, the up-down direction may be replaced with a “vehicle up-down direction”, and the front-rear direction may be replaced with a “vehicle front-rear direction” (these terms may be synonymous).

The window regulator 1 according to the embodiment is mounted inside a door panel at a right front seat (a driver's seat in the case of right-hand drive) of an automobile (vehicle), and lifts and lowers (opens and closes) window glass W at the right front seat (the window glass W is illustrated in FIG. 3). The window regulator 1 may be mounted inside a door panel at a left front seat (a passenger seat in the case of right-hand drive) or a rear seat of an automobile to lift and lower window glass at the seat.

The window regulator 1 includes a base (base plate) 10, a motor unit (drive member) 20, a bracket (lift arm bracket) 30, a bell crank (shoe member) 40, a first arm (main arm, lift arm, arm member) 50, and a second arm (sub-arm, EQ rod, arm member) 60.

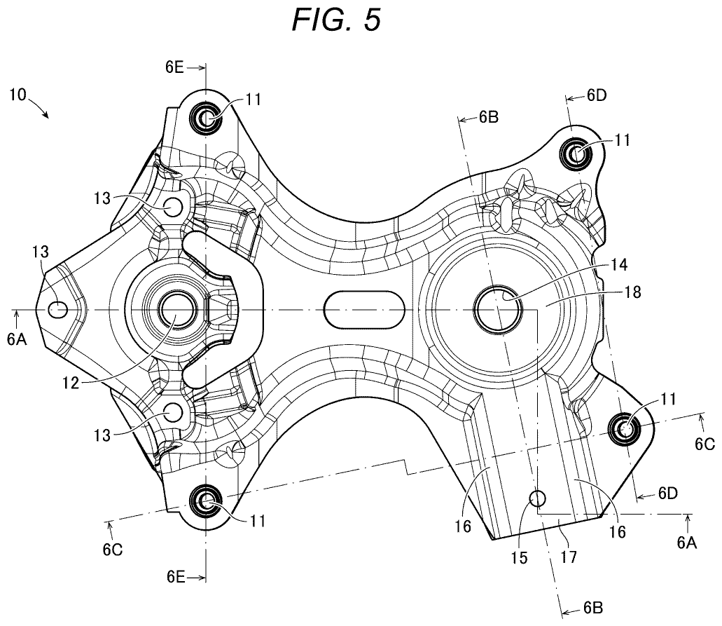

The base 10 is a basic component of the window regulator 1 that directly or indirectly supports the motor unit 20, the bracket 30, the bell crank 40, the first arm 50, the second arm 60, and various other components. The base 10 is assembled to an automobile (vehicle) as a basic component of the window regulator 1 in an assembly (sub-assembly) state (assembly is performed with the base 10 as a reference). As illustrated in FIG. 5 and the like, the base 10 has insertion holes 11 positioned at four corners, and is fastened (fastened together) to a door panel (an inner panel, an outer panel) by four fastening members (not illustrated) inserted through the respective insertion holes 11. That is, the base 10 is assembled to only one of the inner panel and the outer panel of the vehicle. The assembly also includes attachment to a member to be attached to the inner panel or the outer panel. The base may be attached directly or indirectly to the inner panel or the outer panel. Further, the base 10 may correspond to “a vehicle member constituting a door”. Furthermore, although the base 10 of the embodiment is formed of a single member, the base 10 may be implemented by a member obtained by combining (bonding or joining) a plurality of members, or may be implemented by a plurality of members disposed at separate positions. In the case of being implemented by a plurality of members positioned at separate positions, one of the plurality of bases may support a first arm, and another of the plurality of bases may support a second arm.

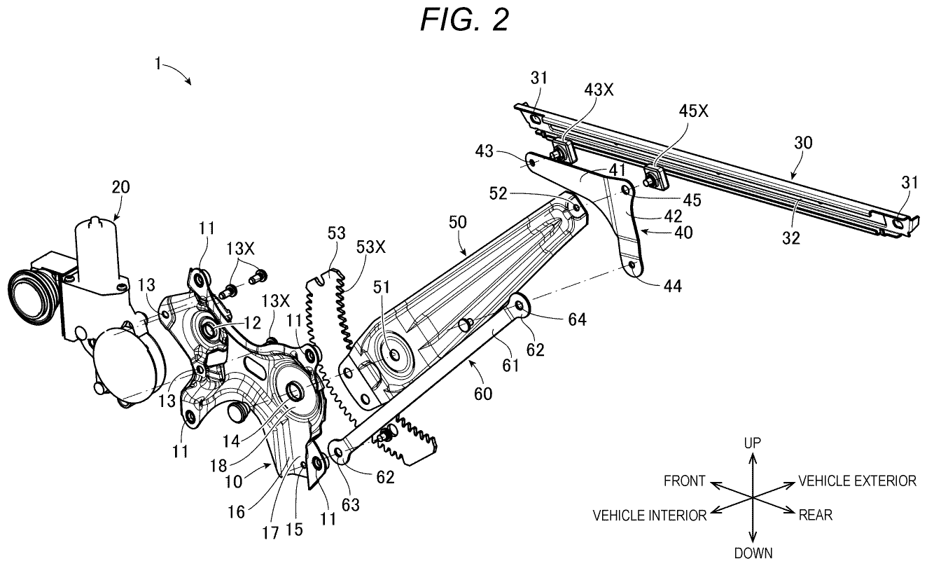

The motor unit 20 includes a motor and a built-in gear mechanism that transmits a rotational driving force of the motor to the first arm 50 (a driven gear 53 described later). As illustrated in FIGS. 2, 5, and the like, the base 10 has a fitting hole 12 and three insertion holes 13 positioned around the fitting hole 12. A center shaft (for example, a serrated shaft) of the built-in gear mechanism of the motor unit 20 is fitted into the fitting hole 12, and three fastening members 13X are inserted into the three insertion holes 13 to be fastened to fastening holes of the motor unit 20, whereby the motor unit 20 is supported by the base 10 (see FIG. 2). In this support state, the rotational driving force of the motor unit 20 is transmitted to the first arm 50 (the driven gear 53 described later).

The bracket 30 is a channel member extending in the front-rear direction (extending direction). Two insertion holes 31 are formed in the bracket 30 on both sides in the front-rear direction, and the window glass W (FIG. 3) is supported by the bracket 30 by two fastening members (not illustrated) inserted into the two insertion holes 31. A slide rail 32 extending in the front-rear direction is formed at an intermediate portion between the two insertion holes 31 in the bracket 30, and the bell crank 40 is supported by the slide rail 32 so as to be slidable in the front-rear direction (extending direction). The bell crank 40 may be regarded as a part of the bracket 30.

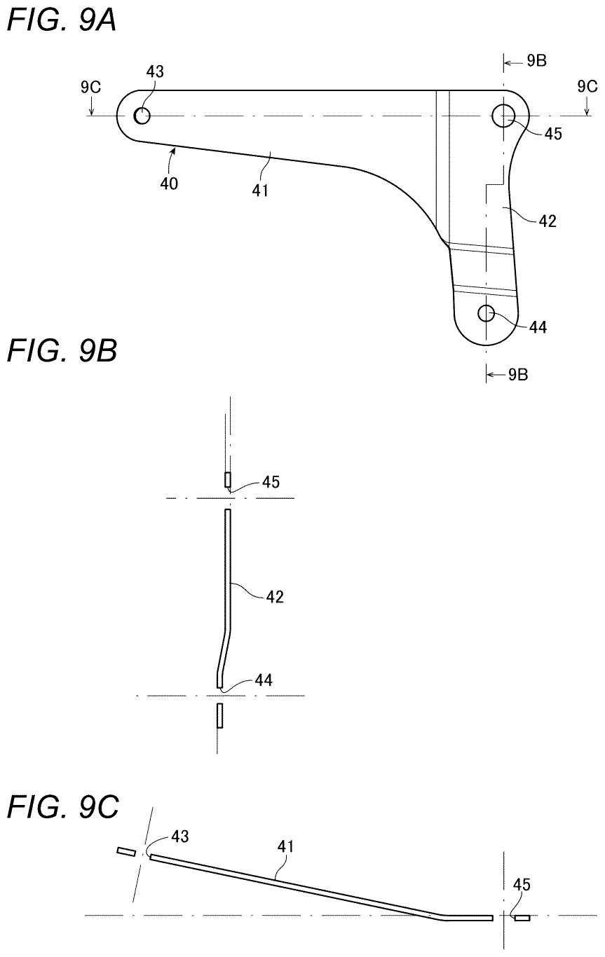

As illustrated in FIGS. 2, 9, and the like, the bell crank 40 is a substantially L-shaped (substantially boomerang-shaped) member including a first side portion 41 extending in the front-rear direction (an extending direction of the slide rail 32 of the bracket 30) and a second side portion 42 bent downward (in a direction intersecting the extending direction of the slide rail 32 of the bracket 30) from a rear end portion of the bracket 30. A through hole 43 is provided in the first side portion 41 at a front side, a through hole (pivot support hole) 44 is provided in the second side portion 42 at a lower side, and a through hole (pivot support hole) 45 is provided in a connection portion of the first side portion 41 and the second side portion 42. Two slider shoes 43X and 45X spaced apart in the front-rear direction are supported by the slide rail 32 of the bracket 30 so as to be slidable in the front-rear direction, a fitting pin of the slider shoe 43X is fitted into the through hole 43, and a fitting pin of the slider shoe 45X is fitted into the through hole 45. In this way, the bell crank 40 is supported by the slide rail 32 of the bracket 30 so as to be slidable in the front-rear direction (extending direction).

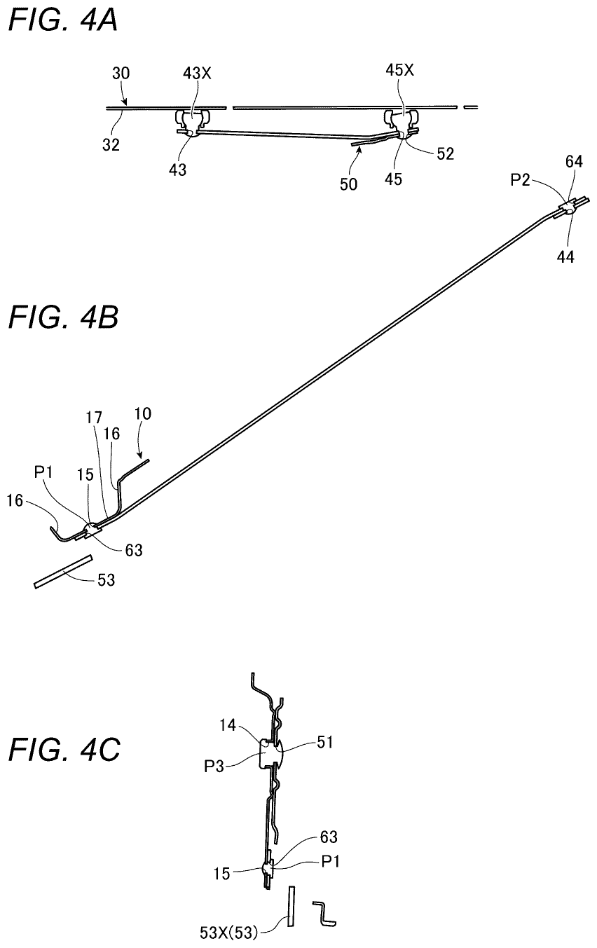

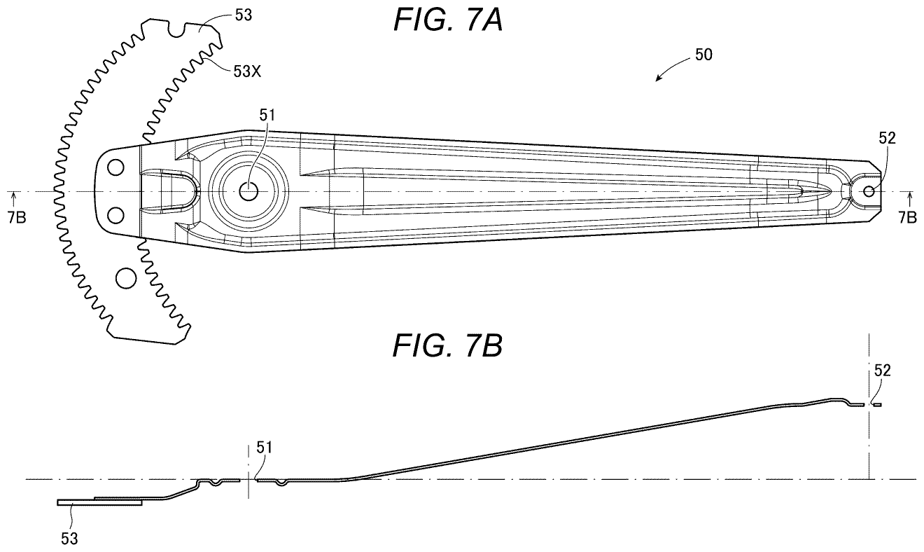

One end of the first arm 50 is rotatably supported by the base 10, and the other end thereof is rotatably supported by the bracket 30 (bell crank 40). As illustrated in FIGS. 2, 7, and the like, a pivot support hole 51 is provided slightly closer to the middle than the one end of the first arm 50, and a pivot support hole 52 is provided at the other end of the first arm 50. The driven gear 53 is provided at the one end of the first arm 50 (closer to a tip end than the pivot support hole 51). The driven gear 53 is a gear member including teeth (gear mechanism) 53X. As illustrated in FIGS. 2, 5, and the like, a pivot support hole 14 is formed in the base 10, and the pivot support hole 14 and the pivot support hole 51 are positioned coaxially for inserting and supporting a pivot support pin P3 (FIG. 4C), whereby the one end of the first arm 50 is rotatably supported by the base 10. In this support state, the driven gear 53 meshes with the center shaft (for example, a serrated shaft) of the built-in gear mechanism of the motor unit 20, and the rotational driving force of the motor unit 20 is transmitted to the first arm 50. Further, the fitting pin of the slider shoe 45X is rotatably inserted and supported in a state where the pivot support hole 52 of the first arm 50 is aligned with the through hole 45 of the bell crank 40. Accordingly, the other end of the first arm 50 is rotatably supported by the bracket 30 (bell crank 40).

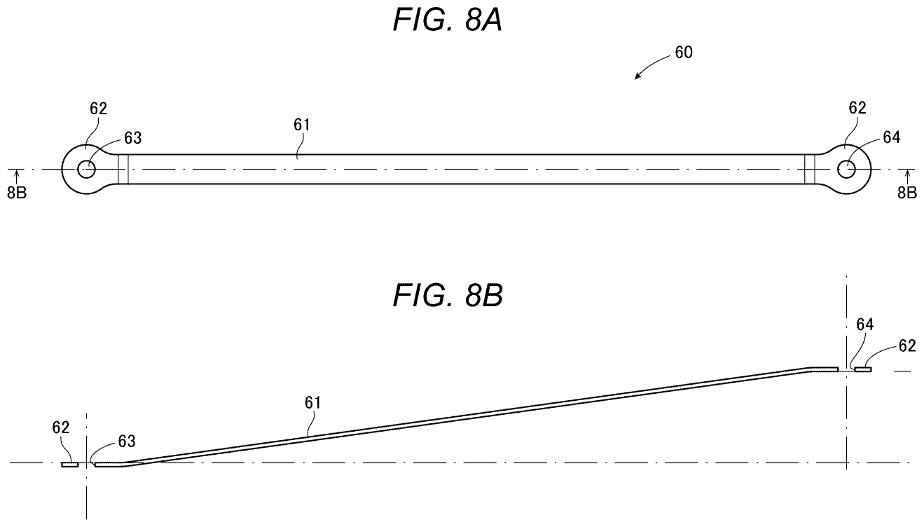

One end of the second arm 60 is rotatably supported by the base 10, and the other end thereof is rotatably supported by the bracket 30 (bell crank 40). As illustrated in FIGS. 2, 8 and the like, the second arm 60 includes a narrow portion 61 positioned intermediate between the one end and the other end, and wide portions 62 positioned at the one end and the other end. A pivot support hole 63 is provided in the wide portion 62 at the one end of the second arm 60, and a pivot support hole 64 is provided in the wide portion 62 at the other end of the second arm 60. As illustrated in FIGS. 2, 5, and the like, a pivot support hole 15 is formed in the base 10, and the pivot support hole 15 and the pivot support hole 63 are positioned coaxially for inserting and supporting a pivot support pin P1 (FIGS. 4B and 4C), whereby the one end of the second arm 60 is rotatably supported by the base 10. Further, a pivot support pin P2 (FIG. 4B) is inserted and supported in a state where the through hole (pivot support hole) 44 of the bell crank 40 is aligned with the pivot support hole 64 of the second arm 60, whereby the other end of the second arm 60 is rotatably supported by the bracket 30 (bell crank 40). As described above, the second arm 60 includes the narrow portion 61 positioned intermediate between the one end and the other end, the wide portion 62 (pivot support hole 63) positioned at the one end and rotatably supported by the base 10, and the wide portion 62 (pivot support hole 64) positioned at the other end and rotatably supported by the bracket 30 (bell crank 40). By forming one end portion and the other end portion of the second arm 60, in which the pivot support holes 63 and 64 are formed, as the wide portions 62, it is possible to ensure the same rigidity as that of the narrow portion 61 (it is possible to ensure uniform rigidity in a longitudinal direction of the second arm 60).

A width of the first arm 50 is larger than a width of the second arm 60 over the longitudinal direction of the first arm 50 and the second arm 60. By optimally setting the width and the arm length of the first arm 50 and the second arm 60, measurement and smooth driving of the first arm 50 and the second arm 60 and the window regulator 1 can be achieved.

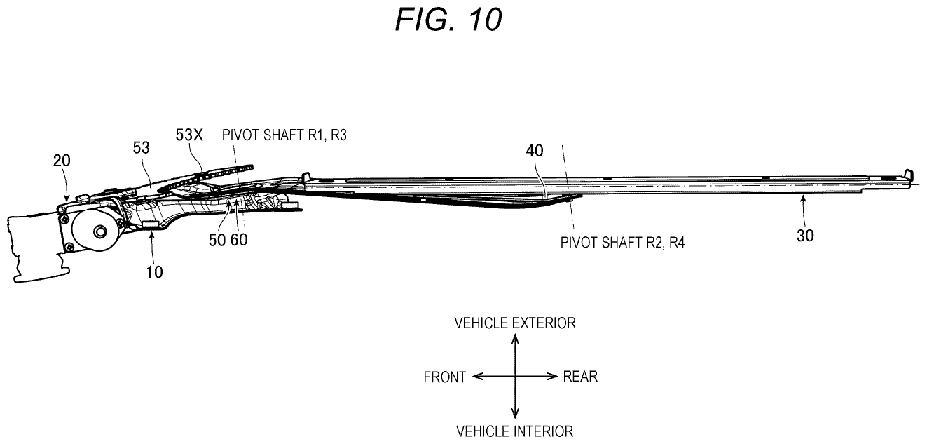

As described later with reference to FIG. 10, as viewed in the up-down direction (vehicle up-down direction), the first arm 50 and the second arm 60 at least partially overlap each other (the first arm 50 and the second arm 60 have portions overlapping each other). Accordingly, a reduction in size (reduction in thickness) of the window regulator 1 in the vehicle width direction can be achieved. In conventional products including that disclosed in Reference 1, the main arm and the sub-arm do not overlap each other in the up-down direction and are disposed apart from each other in the vehicle width direction, which results in an increase in size (increase in thickness) of the window regulator in the vehicle width direction.

The one end of the first arm 50 and the one end of the second arm 60 are rotatably supported by the base 10 so as to be shifted in a drive direction of the bracket 30 supporting the window glass W and the vehicle width direction.

Here, as denoted by reference signs in FIG. 3, a rotation support position (rotation center) of the one end of the first arm 50 to the base 10 is referred to as a “pivot shaft R1”, a rotation support position (rotation center) of the other end of the first arm 50 to the bracket 30 (bell crank 40) is referred to as a “pivot shaft R2”, a rotation support position (rotation center) of the one end of the second arm 60 to the base 10 is referred to as a “pivot shaft R3”, and a rotation support position (rotation center) of the other end of the second arm 60 to the bracket 30 (bell crank 40) is referred to as a “pivot shaft R4”. The pivot shaft R1 to the pivot shaft R4 are different from each other, and four linking pivot fulcrums (four-link regulator) presenting a parallel quadrilateral shape are formed in which a distance between the pivot shaft R1 and the pivot shaft R2 and a distance between the pivot shaft R3 and the pivot shaft R4 form long sides equal to each other, and a distance between the pivot shaft R1 and the pivot shaft R3 and a distance between the pivot shaft R2 and the pivot shaft R4 form short sides equal to each other.

When the rotational driving force of the motor unit 20 is transmitted to the first arm 50 in a state where the base 10 is fixed to the automobile (vehicle), the rotational driving force is also transmitted to the second arm 60. As a result, the bracket 30 and the window glass W are lifted and lowered (driven) in the up-down direction (drive direction). At this time, as indicated by a full-opening position, a full-closing position, and an intermediate position in FIG. 1, the long sides of the four linking pivot fulcrums (the side connecting the pivot shaft R1 and the pivot shaft R2 and the side connecting the pivot shaft R3 and the pivot shaft R4) are parallel to each other, the short sides of the four linking pivot fulcrums (the side connecting the pivot shaft R1 and the pivot shaft R3 and the side connecting the pivot shaft R2 and the pivot shaft R4) are parallel to each other, and the first arm 50 and the second arm 60 do not intersect each other (only angles of the parallel quadrilateral change). The first arm 50, to which the rotational driving force of the motor unit 20 is directly transmitted, performs the main function of lifting and lowering the window glass W, and in that sense may be referred to as a main arm. The second arm 60, to which the rotational driving force of the motor unit 20 is indirectly transmitted, performs a subsidiary function of lifting and lowering the window glass W (also performs a lock function described later), and in that sense may be referred to as a sub-arm. In any case, the motor unit 20 functions as a “drive member” for lifting and lowering (driving) the bracket 30, on which the window glass W is supported, by rotationally driving (directly driving) the first arm 50 with respect to the base 10 and the bracket 30 and rotationally driving (sub-driving) the second arm 60 with respect to the base 10 and the bracket 30.

However, in a window regulator in the related art, there is a problem that, at or near a top dead center of the window glass, a force in a rotation direction is applied to the window glass to rotate the window glass. This phenomenon is caused by an insufficient length of a glass end, and causes a more serious problem in a front door in which the length of the glass end tends to be short (it is unlikely to cause a problem in a rear door in which the length of the glass end is easily secured).

As types of the window regulator in the related art, a single arm type and an X arm type of the window regulator are known. With the single arm type window regulator, particularly when the single arm type window regulator is applied to front window glass, the problem that a force in a rotation direction is applied to the front window glass and the front window glass is rotated cannot be solved completely. On the other hand, although a certain level of effect for preventing the rotation of the window glass can be obtained with the X arm type window regulator, the X arm type window regulator has a complicated structure and a large size, which is likely to lead to an increase in cost.

Therefore, in the window regulator 1 according to the embodiment, four linking pivot fulcrums (four-link regulator) are implemented by the base 10, the bracket 30, the first arm 50, and the second arm 60, and at or near the top dead center of the window glass W, a force that tends to rotate the window glass W forward is received by the cooperation of the first arm 50 and the second arm 60 (falling forward of the window glass W is prevented). More specifically, while the first arm 50 plays a main role of lifting and lowering the bracket 30 (window glass W), at or near the top dead center of the window glass W, the second arm 60 supported by the bell crank 40 directly below the first arm 50 supports the first arm 50 in a subsidiary manner, whereby a force tending to rotate the window glass W forward is received (falling forward of the window glass W is prevented). The four-link regulator according to the embodiment has the advantages of being simple in structure, small in size, and low in cost as compared with the X arm type window regulator.

In the window regulator 1 according to the embodiment, in an assembly (sub-assembly) state prior to installation in an automobile (vehicle), the four linking pivot fulcrums (four-link regulator) are formed by which the one end of the first arm 50 and the one end of the second arm 60 are rotatably supported by the base 10 at different positions, and the other end of the first arm 50 and the other end of the second arm 60 are rotatably supported by the bracket 30 (bell crank 40) at different positions. Therefore, it is possible to simplify the attachment to an automobile (vehicle) (it is possible to simplify the structure and process for the attachment and to reduce the number of steps and variations). More specifically, four fastening members (not illustrated) are inserted into the four insertion holes 11 of the base 10 and fastened (fastened together) to the door panel, thereby completing the attachment of the window regulator 1 to the automobile (vehicle). The window glass W is supported by the bracket 30 at an appropriate timing. On the other hand, in the above-described Reference 1, since the sub-arm is swingably provided on the side beam disposed on the inner side of the door outer panel, the number of steps and the variations in attaching to the automobile (vehicle body) increase.

As illustrated in FIGS. 2, 4B, 6B, 6C, and the like, the base 10 includes sidewall portions 16 extending in the vehicle width direction and a second support flat portion 17 connected to the sidewall portions 16. The sidewall portions 16 and the second support flat portion 17 present a U-shape in a cross-sectional view in which end portions on the vehicle exterior side of a pair of sidewall portions 16 extending in the vehicle width direction are connected by the second support flat portion 17. The pivot support hole 15 is provided in the second support flat portion 17. As illustrated in FIGS. 1 to 3, 5, 6B, and the like, the base 10 includes a first support flat portion 18 positioned around the pivot support hole 14 (the pivot support hole 14 is provided in the first support flat portion 18).

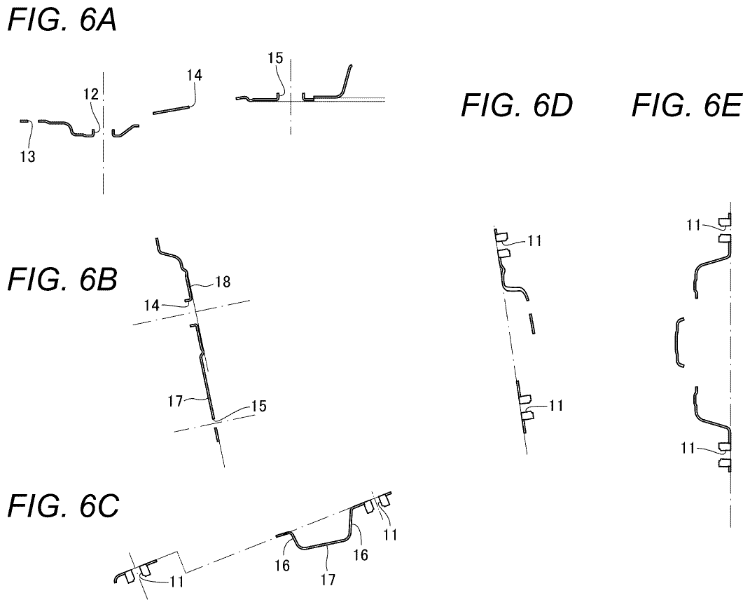

As described above, the base 10 includes the first support flat portion 18 (pivot support hole 14) by which the one end of the first arm 50 is rotatably supported, and the second support flat portion 17 (pivot support hole 15) by which the one end of the second arm 60 is rotatably supported. The first arm 50 the one end of which is supported by the first support flat portion 18 (pivot support hole 14) and the second arm 60 the one end of which is supported by the second support flat portion 17 (pivot support hole 15) are offset in the vehicle width direction. As illustrated in FIG. 6B, the first support flat portion 18 and the second support flat portion 17 are slightly offset in the vehicle width direction. The first arm 50 and the second arm 60 are each gently bent in the vehicle width direction from a rotation support portion of the one end to a rotation support portion of the other end. Taking this degree of bending into consideration, there is an offset in the vehicle width direction from the rotation support portion of the one end to the rotation support portion of the other end. Accordingly, the first arm 50 and the second arm 60 are prevented from interfering with each other during rotation (pivot), and the first arm 50 and the second arm 60 are prevented from interfering with other components (including pinch between both arms), and smoother operations with improved layout efficiency can be implemented.

When a plate surface position where the four insertion holes 11 are formed is set as a reference plane of the base 10, rigidity of a portion (near the pivot shaft R1) supporting one end portion of the first arm 50 is secured by forming the first support flat portion 18 in a dome shape protruding from the reference plane in the vehicle width direction. Further, in order to secure the rigidity of a portion (near the pivot shaft R3) supporting one end portion of the second arm 60, since a support position of the second arm 60 is not very far from a support position of the first arm 50, the pair of sidewall portions 16 and the second support flat portion 17 are formed in a manner of extending in a radial direction from the dome-shaped portion (a foot portion of the first support flat portion 18) (see FIG. 5). Accordingly, the base 10 is easily manufactured by pressing, and an offset amount of the two support flat portions 17 and 18 in the vehicle width direction is also easily controlled. As described, in the side view in FIG. 5, the pair of sidewall portions 16 extend in a radially outward direction of the first support flat portion 18.

By rotatably supporting the one end of the second arm 60 on the second support flat portion 17 (the pivot support hole 15) forming a connection portion having a U-shape in a cross-sectional view, it is possible to appropriately set (adjust) the position of a rotation support shaft (the pivot support pin P1) in the vehicle width direction and to maintain high rigidity of a connection portion of the second arm 60 and the base 10. In Reference 1 described above, since the main arm and the sub-arm are supported in a state of being separated from each other in the vehicle width direction, the rigidity of the arm members is insufficient, which leads to accuracy deterioration and variations for assembly.

In the window regulator 1 (a four-link window regulator having four different rotation support positions) according to the embodiment, the one end of the first arm 50 and the one end of the second arm 60 are rotatably supported by the base 10, and the other end of the first arm 50 and the other end of the second arm 60 are rotatably supported by the bracket 30 (bell crank 40). Moreover, as illustrated in FIGS. 1 to 3 and the like, a rotation center shaft of the one end of the first arm 50 and a rotation center shaft of the one end of the second arm 60 are shifted in the drive direction (up-down direction) of the bracket 30 on which the window glass W is supported, and a rotation center shaft of the other end of the first arm 50 and a rotation center shaft of the other end of the second arm 60 are shifted in the drive direction (up-down direction) of the bracket 30 on which the window glass W is supported.

In FIG. 3, focusing on a positional relationship between the pivot shaft R1 and the pivot shaft R3, the pivot shaft R1 and the pivot shaft R3 are largely offset in the up-down direction, are (almost) not offset in the front-rear direction, and are offset in the vehicle width direction to the extent of preventing interference between the first arm 50 and the second arm 60. Similarly, focusing on a positional relationship between the pivot shaft R2 and the pivot shaft R4, the pivot shaft R2 and the pivot shaft R4 are largely offset in the up-down direction, are (almost) not offset in the front-rear direction, and are offset in the vehicle width direction to the extent of preventing interference between the first arm 50 and the second arm 60. As illustrated in FIG. 1, the positional relationship between the pivot shaft R1 and the pivot shaft R3 and the positional relationship between the pivot shaft R2 and the pivot shaft R4 are normally kept the same regardless of pivot positions of the first arm 50 and the second arm 60 (opening degree of the window glass W). Accordingly, the first arm 50 and the second arm 60 do not overlap (intersect) each other when rotating, and as a result, it is possible to prevent a local force (a force to cause deformation) from being applied to the first arm 50 and the second arm 60.

In Reference 1 described above, rotation support portions of one ends of the main arm and the sub-arm are offset only in the vehicle front-rear direction (positions in the up-down direction are the same), and rotation support portions of the other ends of the main arm and the sub-arm are offset only in the vehicle front-rear direction (positions in the up-down direction are the same). Since the main arm and the sub-arm overlap (intersect) each other when rotating, a local force (a force to cause deformation) is applied to the main arm and the sub-arm. More specifically, since a moment arm applied to the overlapping (intersecting) main arm and sub-arm is infinite, in particular, a load applied to the sub-arm increases, which leads to an increase in the size of the sub-arm (it is necessary to increase the size thereof).

The window glass W is fixed to the bracket 30 by two fastening members (not illustrated) that are inserted through the two insertion holes 31, respectively. When the window glass W is about to rotate, a rotation shaft of the window glass W generates a moment caused by the positional relationship between the pivot shaft R1 and the pivot shaft R4 in FIG. 3. In particular, in order to stop (inhibit) a rotational moment M about the pivot shaft R2, a force P in a direction in which the second arm 60 is pulled due to the bell crank 40 is required, and the force P is expressed as P=M/L, where L is a distance between the long sides of the four linking pivot fulcrums (four-link regulator). In Reference 1 described above, at a timing when the main arm and the sub-arm overlap (intersect), L=0 and the force P is infinite, and as a result, a local force (a force to cause deformation) is applied to the main arm and the sub-arm. In this regard, in the window regulator 1 according to the embodiment, the distance L between the long sides of the four linking pivot fulcrums (the four-link regulator) is normally constant, and thus the force P is maintained at a level that prevents rotation of the window glass W, and it is possible to prevent a local force (a force to cause deformation) from being applied to the first arm 50 and the second arm 60. Further, the window regulator 1 (window glass W) can be stably driven.

The bracket 30 includes the bell crank 40 that is slidable in the extending direction (front-rear direction) of the slide rail 32 of the bracket 30, and the other end of the first arm 50 and the other end of the second arm 60 are rotatably supported by the bell crank 40 so as to be shifted in the drive direction (up-down direction) of the bracket 30 on which the window glass W is supported (see the pivot shaft R2 and the pivot shaft R4 in FIG. 3). By rotatably supporting the other end of the first arm 50 and the other end of the second arm 60 in an offset state via the bell crank 40, the window regulator 1 (window glass W) can be stably driven.

The bell crank 40 is a substantially L-shaped (substantially boomerang-shaped) member including the first side portion 41 extending in the front-rear direction (the extending direction of the slide rail 32 of the bracket 30) and the second side portion 42 bent downward (in a direction intersecting the extending direction of the slide rail 32 of the bracket 30) from the rear end portion of the bracket 30. The other end of the first arm 50 is rotatably supported by the connection portion of the first side portion 41 and the second side portion 42 (pivot shaft R2 in FIG. 3), and the other end of the second arm 60 is rotatably supported by the second side portion 42 (pivot shaft R4 in FIG. 3). An angle formed by the first side portion 41 and the second side portion 42 of the bell crank 40 may be a right angle, an acute angle, or an obtuse angle, and is preferably, for example, 80° or more and 100° or less in order to implement the offset in the up-down direction between the pivot shaft R2 the pivot shaft R4. In particular, by setting the angle formed by the first side portion 41 and the second side portion 42 of the bell crank 40 to be an acute angle (for example, 80° or more and less than) 90°, it is possible to reduce the input of the load to the first arm 50 and the second arm 60 (reduce a difference in input load) at and near the top dead center of the window glass W and at and near a bottom dead center.

In the window regulator 1 according to the embodiment, in a movable range of the first arm 50, a line segment connecting the rotation center of the one end and the rotation center of the other end of the first arm 50 (line segment connecting the pivot shaft R1 and the pivot shaft R2) does not overlap the rotation center (pivot shaft R3) of the one end and the rotation center (pivot shaft R4) of the other end of the second arm 60. Accordingly, damage to the window regulator 1 can be prevented in the movable range of the first arm 50, and the window regulator 1 (window glass W) can be stably driven.

In the window regulator 1 according to the embodiment, when the window glass W is positioned at the bottom dead center, a shift amount in the drive direction (up-down direction) between the rotation support portion (pivot shaft R1) of the one end of the first arm 50 and the rotation support portion (pivot shaft R3) of the one end of the second arm 60 and a shift amount in the drive direction (up-down direction) between the rotation support portion (pivot shaft R2) of the other end of the first arm 50 and the rotation support portion (pivot shaft R4) of the other end of the second arm 60 are smaller than a distance between the rotation center (pivot shaft R2) of the other end of the first arm 50 and a lower surface of a vehicle door panel. Accordingly, even when the window glass W is positioned at the bottom dead center, interference with the vehicle door panel can be prevented, and the window regulator 1 (window glass W) can be stably driven.

However, in the window regulator device disclosed in Reference 1 described above, there is a problem that an undesirable force acts on the window glass due to a deviation between a lifting and lowering trajectory of the window glass and driving trajectories of the main arm and the sub-arm, and smooth lifting and lowering is inhibited. This problem is caused by a fact that the main arm and the sub-arm present a linear track while the window glass presents a track having a curvature together with a door frame, and a fact that the rotation center shafts (rotation support shaft) of the main arm and the sub-arm are oriented in the vehicle width direction. A pulling force is generated when lifting or lowering the window glass due to bending of the main arm and the sub-arm, and a pushing force is generated when the window glass is completely closed.

In the window regulator 1 according to the embodiment, in order to solve the above problem, driving trajectories of the window glass W and the arm members (first arm 50 and second arm 60) are brought close to each other to reduce the action of force on the window glass W, thereby achieving smooth driving. Therefore, at least one of the rotation center shaft of the one end and the rotation center shaft of the other end of the arm member (the first arm 50 and the second arm 60) is inclined in the front-rear direction (the vehicle front-rear direction) with respect to the vehicle width direction when viewed in the up-down direction (the vehicle up-down direction). More specifically, at least one of the rotation center shaft (pivot shaft R1) of the one end of the first arm 50, the rotation center shaft (pivot shaft R2) of the other end of the first arm 50, the rotation center shaft (pivot shaft R3) on the one end of the second arm 60, and the rotation center shaft (pivot shaft R4) of the other end of the second arm 60 is inclined in the front-rear direction (vehicle front-rear direction) with respect to the vehicle width direction when viewed from the up-down direction (the vehicle up-down direction).

At least one of the rotation center shaft of the one end and the rotation center shaft of the other end of the arm member (first arm 50 and second arm 60) is inclined so as to be directed in the vehicle front-rear direction (front side or rear side) as advancing in a vehicle exterior direction when viewed in the up-down direction. More specifically, at least one of the rotation center shaft (pivot shaft R1) of the one end of the first arm 50, the rotation center shaft (pivot shaft R2) of the other end of the first arm 50, the rotation center shaft (pivot shaft R3) of the one end of the second arm 60, and the rotation center shaft (pivot shaft R4) of the other end of the second arm 60 is inclined so as to be directed in the vehicle front-rear direction (front side or rear side) as advancing in the vehicle exterior direction when viewed in the up-down direction.

As illustrated in FIG. 10, the one end of the first arm 50 is rotatably supported at the rotation center shaft (pivot shaft R1) with respect to the base 10, and as viewed from the up-down direction, the rotation center shaft (pivot shaft R1) is inclined so as to be directed in the vehicle front-rear direction (front side) as advancing in the vehicle exterior direction. Further, the one end of the second arm 60 is rotatably supported at the rotation center shaft (pivot shaft R3) with respect to the base 10, and as viewed from the up-down direction, the rotation center shaft (pivot shaft R3) is inclined so as to be directed in the vehicle front-rear direction (front side) as advancing in the vehicle exterior direction. In FIG. 10, since the pivot shafts R1 and R3 overlap each other in the up-down direction, the pivot shafts R1 and R3 are indicated by a single axis.

As illustrated in FIG. 10, the other end of the first arm 50 is rotatably supported at the rotation center shaft (pivot shaft R2) with respect to the bracket 30 (bell crank 40), and as viewed from the up-down direction, the rotation center shaft (pivot shaft R2) is inclined so as to be directed in the vehicle front-rear direction (rear side) as advancing in the vehicle exterior direction. Further, the other end of the second arm 60 is rotatably supported by at the rotation center shaft (pivot shaft R4) with respect to the bracket 30 (bell crank 40), and as viewed from the up-down direction, the rotation center shaft (pivot shaft R4) is inclined so as to be directed in the vehicle front-rear direction (rear side) as advancing in the vehicle exterior direction. In FIG. 10, since the pivot shafts R2 and R4 overlap each other in the up-down direction, the pivot shafts R2 and R4 are indicated by a single axis.

At least one of the rotation center shaft of the one end and the rotation center shaft of the other end of the arm member (first arm 50 and second arm 60) is inclined so as to be directed toward the front side in the vehicle front-rear direction as advancing in the vehicle exterior direction as viewed in the vehicle up-down direction in a case where the rotation center shaft of the other end is positioned at the rear side in the vehicle front-rear direction with respect to the rotation center shaft of the one end, and is inclined so as to be directed toward the rear side in the vehicle front-rear direction as advancing in the vehicle exterior direction as viewed in the vehicle up-down direction in a case where the rotation center shaft of the other end is positioned at the front side in the vehicle front-rear direction with respect to the rotation center shaft of the one end.

Regarding the degree of inclination of the pivot shaft R1 to the pivot shaft R4, taking curvatures of a general window glass and a general door frame into consideration, when the rotation shaft is rotated toward the front side or rear side by about 10° with respect to the vehicle width direction as a reference, an operation corresponding to (following) the curvatures of the window glass and the door frame is possible. However, regarding the degree of inclination of the pivot shaft R1 to the pivot shaft R4, various design changes can be made according to the curvatures of the window glass and the door frame (for example, even if an inclination angle that is not the most preferable inclination angle is set, certain effects can be obtained). A wire type regulator has an advantage of being able to easily follow the lifting and lowering trajectory of the window glass, and the window regulator 1 according to the embodiment has an advantage of being able to follow the lifting and lowering trajectory of the window glass at the same level as the wire type regulator while employing the four linking pivot fulcrums (four-link regulator).

By inclining the rotation center shaft (pivot shaft) to reduce the generation of the force in the vehicle width direction applied to the window glass W, it is possible to prevent a pulling force from being applied by the first arm 50 and the second arm 60 when lifting and lowering the window glass W and to prevent a pushing force from being generated when the window glass W is completely closed, and it is possible to achieve smooth lifting and lowering (driving) of the window glass W. Further, the rotation of the window glass W can be prevented by the four linking pivot fulcrums (four-link regulator).

As illustrated in FIG. 10, the first arm 50 has a relatively large degree of inclination with respect to the vehicle front-rear direction at the rotation support portion (rotation center shaft or the vicinity thereof) of the one end and the rotation support portion (rotation center shaft or the vicinity thereof) of the other end, and has a relatively small degree of inclination with respect to the vehicle front-rear direction at an intermediate portion between the one end and the other end. For example, from the front side toward the rear side, the first arm 50 may be relatively steeply inclined toward the vehicle exterior side in the vicinity of the rotation support portion of the one end, relatively gently inclined toward the vehicle interior side or the vehicle exterior side at the intermediate portion between the one end and the other end, and relatively steeply inclined toward the vehicle exterior side in the vicinity of the rotation support portion of the other end. By optimally setting the degree of inclination of the first arm 50 according to the position in the front-rear direction, the size of the first arm 50 in the vehicle width direction can be reduced, and the window regulator 1 can be disposed with high layout efficiency even in a narrow space in the door panel. The intermediate portion may extend in the front-rear direction, and may not be inclined to the vehicle interior side or the vehicle exterior side. The degree of inclination of the intermediate portion being relatively small includes a case where the inclination is not provided.

Similarly, the second arm 60 has a relatively large degree of inclination with respect to the vehicle front-rear direction at the rotation support portion (rotation center shaft or the vicinity thereof) of the one end and the rotation support portion (rotation center shaft or the vicinity thereof) of the other end, and has a relatively small degree of inclination with respect to the vehicle front-rear direction at an intermediate portion between the one end and the other end. For example, from the front side toward the rear side, the second arm 60 may be relatively steeply inclined toward the vehicle exterior side in the vicinity of the rotation support portion of the one end, relatively gently inclined toward the vehicle interior side or the vehicle exterior side at the intermediate portion between the one end and the other end, and relatively steeply inclined toward the vehicle exterior side in the vicinity of the rotation support portion of the other end. By optimally setting the degree of inclination of the second arm 60 according to the position in the front-rear direction, the size of the second arm 60 in the vehicle width direction can be reduced, and the window regulator 1 can be disposed with high layout efficiency even in a narrow space in the door panel. The intermediate portion may extend in the front-rear direction, and may not be inclined to the vehicle interior side or the vehicle exterior side. The degree of inclination of the intermediate portion being relatively small includes a case where the inclination is not provided.

As illustrated in FIG. 4A, when the pivot shaft R2 of the other end of the first arm 50 is inclined, a base portion of the slider shoe 45X is not inclined, and thus smooth sliding in the front-rear direction with respect to the slide rail 32 is ensured. Only a displacement support portion, which is supported on the base portion of the slider shoe 45X with a play and has the fitting pin, is inclined. As described above, since the slider shoe includes the base portion and the displacement support portion that is supported on the base portion with a play and has the fitting pin, it is possible to flexibly incline the pivot shaft while absorbing variations in assembly.

The window regulator 1 according to the embodiment includes the driven gear (gear member) 53 formed with the teeth (gear mechanism) 53X that transmit the rotational driving force of the motor unit (drive member) 20 to the arm members (the first arm 50 and the second arm 60). As illustrated in FIG. 10, the teeth 53X of the driven gear 53 are inclined in the vehicle front-rear direction with respect to the vehicle width direction as viewed in the vehicle up-down direction. That is, an inclination amount of the teeth 53X of the driven gear 53 coincides with an inclination amount in the vicinity of the rotation support portion (rotation center shaft or the vicinity thereof) of the one end of the first arm 50 and the second arm 60. By optimally setting the inclination amount of the teeth 53X of the driven gear 53, even when the rotation center shaft (pivot shaft) of the arm member (the first arm 50, the second arm 60) is inclined, it is possible to favorably maintain the meshing between the center shaft (for example, the serrated shaft) of the built-in gear mechanism of the motor unit 20 and the teeth 53X of the driven gear 53.

On the other hand, since the base 10 is fastened (fastened together) to the door panel by the fastening members (not illustrated) inserted into the four insertion holes 11, an axial direction of the fastening members (insertion holes 11) is oriented in the vehicle width direction, and is not parallel to the rotation center shaft of the one end or the rotation center shaft of the other end (both inclined) of the arm member (first arm 50 and second arm 60). Accordingly, assembly of the window regulator 1 can be simplified.

Here, first and second directions opposite to each other (for example, one direction and the other direction in the vehicle front-rear direction) are defined. In this case, when the first arm 50 and the second arm 60 extend in the first direction and the window glass W rotates in the first direction about the other end of the first arm 50, the second arm 60 is disposed above the first arm 50. On the other hand, when the first arm 50 and the second arm 60 extend in the first direction and the window glass W rotates in the second direction about the other end of the first arm 50, the second arm 60 is disposed below the first arm 50. Accordingly, the second arm 60 can withstand tension, and withstand higher load than with compression. Also, a reduction in size of the second arm 60 can be achieved.

More specifically, when an arrangement state in FIG. 3 is assumed, the first arm 50 and the second arm 60 extend from a vehicle front side to a vehicle rear side. When the window glass W rotates toward the vehicle rear side about the other end of the first arm 50, the second arm 60 is disposed above the first arm 50. On the other hand, when the window glass W rotates toward the vehicle front side about the other end of the first arm 50, the second arm 60 is disposed below the first arm 50.

When it is assumed that the arrangement state in FIG. 3 is reversed (the vehicle front side and the vehicle rear side of the arrangement in FIG. 3 are reversed), the first arm 50 and the second arm 60 extend from the vehicle rear side to the vehicle front side. When the window glass W rotates toward the vehicle front side about the other end of the first arm 50, the second arm 60 is disposed above the first arm 50. On the other hand, when the window glass W rotates toward the vehicle rear side about the other end of the first arm 50, the second arm 60 is disposed below the first arm 50.

In the window regulator device disclosed in Reference 1 described above, the link is provided with two shoes for enabling movement along the longitudinal direction in the guide rail. However, since a connecting portion of the main arm and the link is provided at a vehicle front side with respect to the two shoes, if a distance between the two shoes is increased so as not to cause rattling, a distance from the main arm serving as the rotation center is increased when the window glass is inclined, and a load is applied to the two shoes when the window glass is rotated. As a result, a moment increases due to the separation between the rotation center and the portion to which the load is applied, and the link may be deformed.

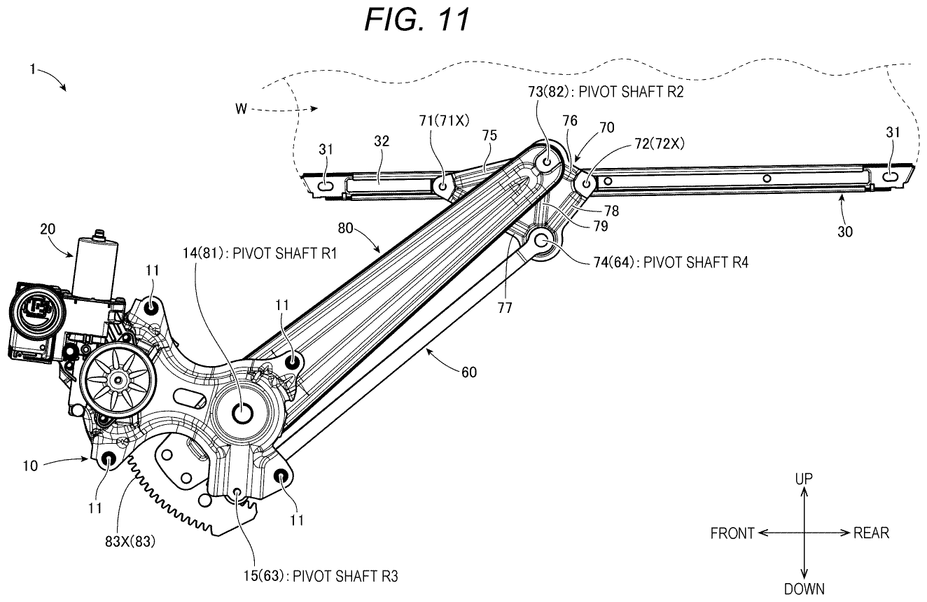

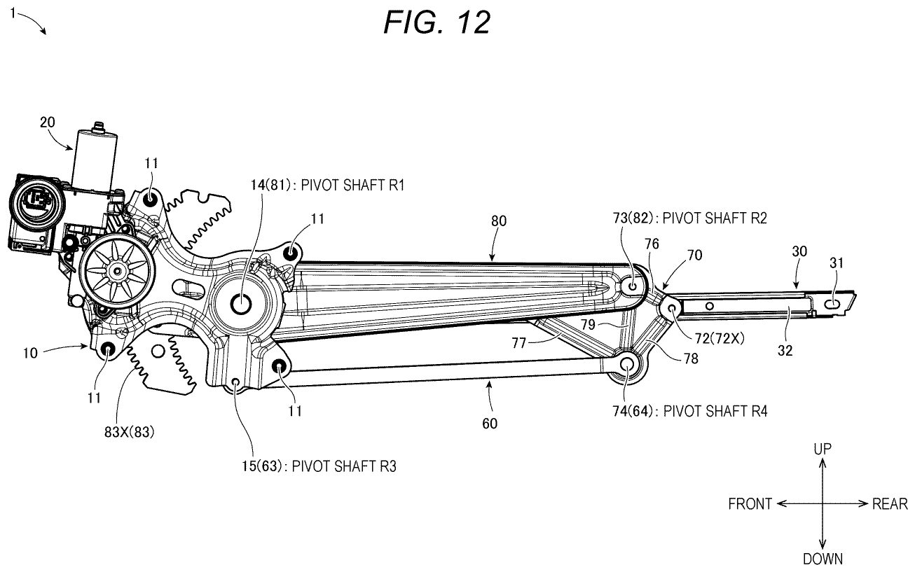

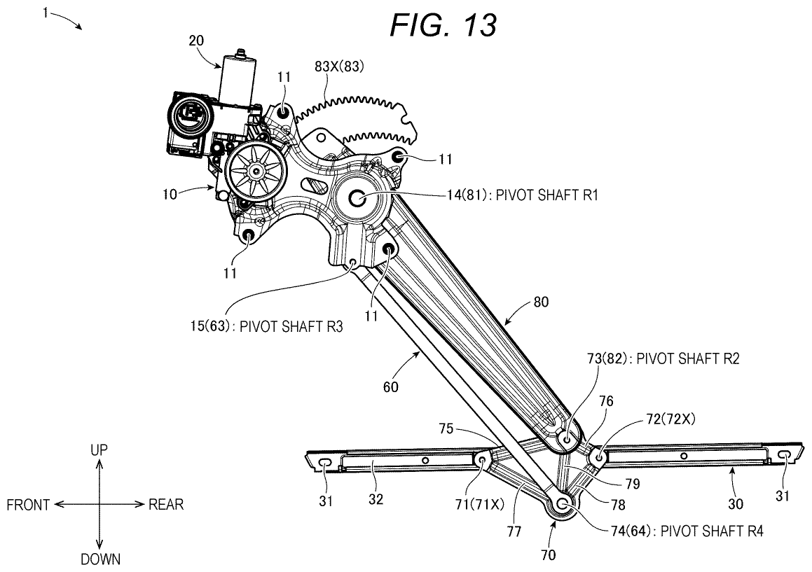

Hereinafter, taking the above problem as a critical technical problem, a window regulator according to another embodiment capable of preventing the deformation of the bracket by reducing the load and the moment applied to the two shoe members on the bracket will be described with reference to FIGS. 11 to 17. In the description of the other embodiment, portions common to those in FIGS. 1 to 10 are denoted by the same reference signs, and repeated description thereof will be omitted.

FIGS. 11, 12, and 13 are views illustrating a full-opening position, an intermediate position, and a full-closing position of a window regulator according to another embodiment as viewed from a vehicle width direction. In the window regulator according to the other embodiment, configurations of the base 10, the motor unit 20, the bracket 30, and the second arm 60 are the same as those of the embodiment in FIGS. 1 to 10. The window regulator according to the other embodiment includes a bell crank 70 and a first arm 80 instead of the bell crank 40 and the first arm 50 of the embodiment in FIGS. 1 to 10. In the window regulator according to the other embodiment, the bell crank 70 may constitute a part of the bracket 30 (the bell crank 70 may be provided in the bracket 30).

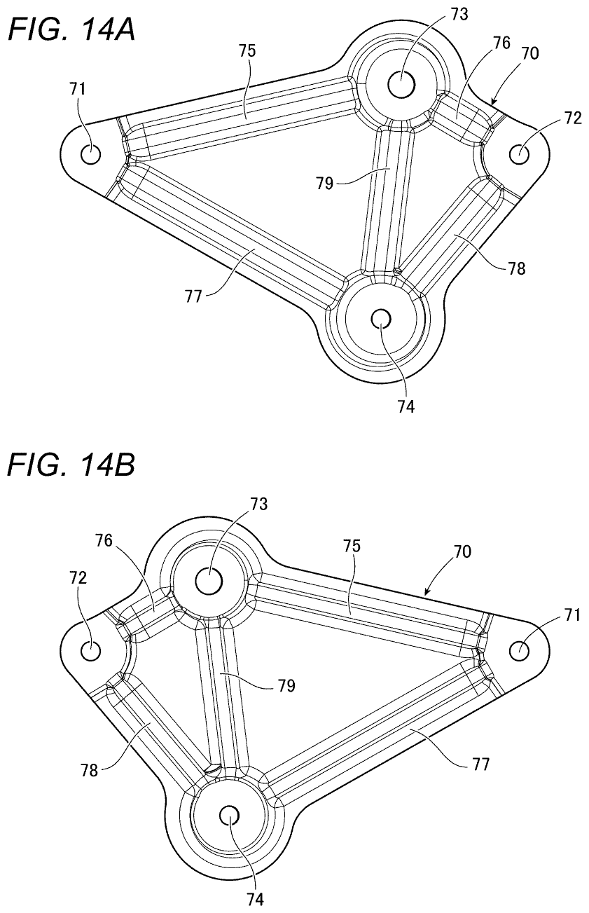

FIGS. 14A and 14B are enlarged views illustrating a single structure of the bell crank 70. The bell crank 70 includes sliding support holes 71 and 72 spaced apart in a front-rear direction. The sliding support hole 71 is positioned at a front side, and the sliding support hole 72 is positioned at a rear side. The bell crank 70 has pivot support holes 73 and 74 that are positioned between the sliding support holes 71 and 72 in the front-rear direction and are spaced apart from each other so as to sandwich the sliding support holes 71 and 72 in an up-down direction. The pivot support hole 73 is positioned at an upper side, and the pivot support hole 74 is positioned at a lower side. The bell crank 70 has a quadrangular shape (rhombus shape) having the sliding support holes 71 and 72 and the pivot support holes 73 and 74 as apexes.

Two slider shoes (shoe members) 71X and 72X spaced apart in the front-rear direction are supported by the slide rail 32 of the bracket 30 so as to be slidable in the front-rear direction, and a fitting pin of the slider shoe 71X is fitted into the sliding support hole 71, and a fitting pin of the slider shoe 72X is fitted into the sliding support hole 72. In this way, the bell crank 70 is supported by the slide rail 32 of the bracket 30 so as to be slidable in the front-rear direction (extending direction). The cost can be reduced by using a common fitting pin for the slider shoes 71X and 72X. The cost can be reduced by using the slider shoes 71X and 72X themselves in common. However, a common member may not be used.

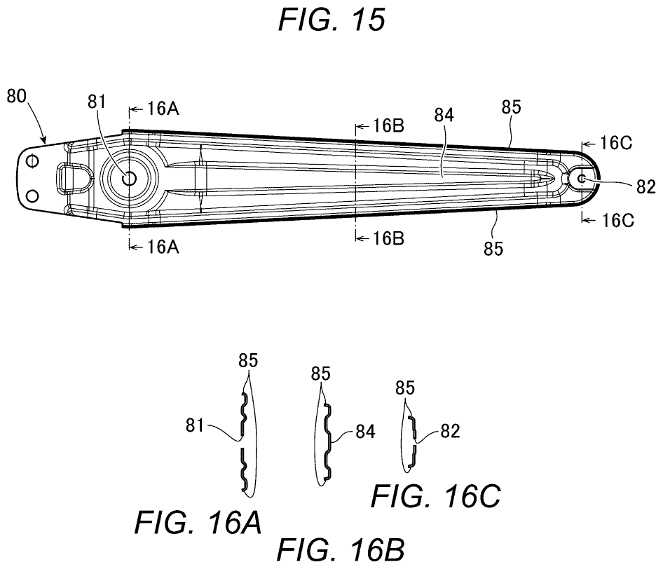

One end of the first arm 80 is rotatably supported by the base 10, and the other end thereof is rotatably supported by the bell crank 70 (bracket 30). As illustrated in FIGS. 15, 16, and the like, a pivot support hole 81 is provided slightly closer to the middle than the one end of the first arm 80, and a pivot support hole 82 is provided at the other end of the first arm 80. A driven gear 83, which is a gear member including teeth (gear mechanism) 83X, is provided at the one end of the first arm 80 (closer to a tip end than the pivot support hole 81) (FIGS. 11 to 13). The pivot support hole 14 of the base 10 and the pivot support hole 81 of the first arm 80 are coaxially positioned to insert and support a pivot support pin (not illustrated), whereby the one end of the first arm 80 is rotatably supported by the base 10. In this support state, the driven gear 83 meshes with the center shaft (for example, a serrated shaft) of the built-in gear mechanism of the motor unit 20, and a rotational driving force of the motor unit 20 is transmitted to the first arm 80. Further, the pivot support hole 82 of the first arm 80 and the pivot support hole 73 of the bell crank 70 are coaxially positioned to insert and support a pivot support pin (not illustrated), whereby the other end of the first arm 80 is rotatably supported by the bell crank 70 (bracket 30).

As illustrated in FIGS. 15 and 16, as in a cross-sectional view, the first arm 80 includes a central bead 84 extending in a longitudinal direction at a central portion in the short-length direction, and a peripheral flange 85 extending in the longitudinal direction at both end portions in the short-length direction. The strength (rigidity) of the first arm 80 can be improved by the central bead 84 and the peripheral flange 85.

Here, as described above, in the window regulator device disclosed in Reference 1, since a connecting portion of the main arm and the link is provided at a vehicle front side with respect to the two shoes, if a distance between the two shoes is increased so as not to cause rattling, a distance from the main arm serving as the rotation center is increased when the window glass is inclined, and a load is applied to the two shoes when the window glass is rotated. As a result, a moment increases due to the separation between the rotation center and the portion to which the load is applied, and the link may be deformed.

In the window regulator 1 according to the embodiment, in order to solve the problem, a configuration for preventing deformation of the bracket 30 (bell crank 70) by reducing a load and a moment applied to the two slider shoes (shoe members) 71X and 72X of the bracket 30 (bell crank 70) is provided.

More specifically, the bell crank 70 constituting the bracket 30 includes the two slider shoes 71X and 72X spaced apart from each other in the vehicle front-rear direction, and the rotation center shaft (pivot shaft R2) of the other end of the first arm 80 is positioned between the two slider shoes 71X and 72X in the vehicle front-rear direction. Similarly, the rotation center shaft (pivot shaft R4) of the other end of the second arm 60 is positioned between the two slider shoes 71X and 72X in the vehicle front-rear direction. In FIGS. 11 to 13, when two straight lines extending in the vehicle up-down direction (vertical) through center shafts of the two slider shoes 71X and 72X are defined, the rotation center shaft (pivot shaft R2) of the other end of the first arm 80 and the rotation center shaft (pivot shaft R4) of the other end of the second arm 60 are disposed so as to fall between the two straight lines.

As described above, since the rotation center shaft (pivot shaft R2) of the other end of the first arm 80 and the rotation center shaft (pivot shaft R4) of the other end of the second arm 60 are positioned between the two slider shoes 71X and 72X in the vehicle front-rear direction, the distance between the two slider shoes 71X and 72X is secured, and a distance between the rotation center shaft (pivot shaft R2) of the other end of the first arm 80 and the rotation center shaft (pivot shaft R4) of the other end of the second arm 60 and the two slider shoes 71X and 72X can be set to be short. Accordingly, the load and the moment applied to the two slider shoes 71X and 72X of the bracket 30 (bell crank 70) can be reduced, and the deformation of the bracket 30 (bell crank 70) can be prevented.

Further, the rotation center shaft (pivot shaft R2) of the other end of the first arm 80 and the rotation center shaft (pivot shaft R4) of the other end of the second arm 60 are shifted to a vehicle upper side or a vehicle lower side with respect to the two slider shoes 71X and 72X in the vehicle up-down direction. The rotation center shaft (pivot shaft R2) of the other end of the first arm 80 is shifted to the vehicle upper side with respect to the two slider shoes 71X and 72X in the vehicle up-down direction, and the rotation center shaft (pivot shaft R4) of the other end of the second arm 60 is shifted to the vehicle lower side with respect to the two slider shoes 71X and 72X in the vehicle up-down direction. In FIGS. 11 to 13, when one straight line extending horizontally through the center shafts of the two slider shoes 71X and 72X is defined, the rotation center shaft (pivot shaft R2) of the other end of the first arm 80 is positioned above the one straight line, and the rotation center shaft (pivot shaft R4) of the other end of the second arm 60 is positioned below the one straight line. With this configuration, the rotation center shaft (pivot shaft R2) of the other end of the first arm 80 and the rotation center shaft (pivot shaft R4) of the other end of the second arm 60 are disposed symmetrically with respect to the two slider shoes 71X and 72X, and thus it is possible to improve the layout efficiency.

Other vehicle members (for example, a door panel and a bracket) are often positioned at a lateral side of the bracket 30, on which the two slider shoes 71X and 72X are supported so as to be slidable, in a state in which the window regulator 1 is assembled to an automobile (vehicle). In this regard, as in the other embodiment, since the rotation center shaft (pivot shaft R2) of the other end of the first arm 80 and the rotation center shaft (pivot shaft R4) of the other end of the second arm 60 are shifted to the vehicle upper side or the vehicle lower side with respect to the two slider shoes 71X and 72X in the vehicle up-down direction, even after the two slider shoes 71X and 72X are attached to the slide rail 32 of the bracket 30, the other ends of the first arm 80 and the second arm 60 can be attached to the bell crank 70 (bracket 30) without being hindered by the other vehicle members. As a result, the degree of freedom of assembly can be improved.

Even with the above designs, the load and the moment applied to the bracket 30 and the bell crank 70 via the two slider shoes 71X and 72X cannot be completely reduced to zero (but there is no occurrence of deformation of the bracket). Therefore, in the embodiment, in order to more reliably secure the rigidity of the bell crank 70 and to reduce the size of the bell crank 70, a bead is formed on the bell crank 70.

As mainly illustrated in FIGS. 14A and 14B, the bell crank 70 includes a bead positioned between the rotation center shaft (pivot shaft R2) of the other end of the first arm 80, the rotation center shaft (pivot shaft R4) of the other end of the second arm 60, and the two slider shoes 71X and 72X. The bead includes beads connecting the rotation center shaft (pivot shaft R2) of the other end of the first arm 80 and the two slider shoes 71X and 72X, beads connecting the rotation center shaft (pivot shaft R4) of the other end of the second arm 60 and the two slider shoes 71X and 72X, and a bead connecting the rotation center shaft (pivot shaft R2) of the other end of the first arm 80 and the rotation center shaft (pivot shaft R4) of the other end of the second arm 60.

In the drawing, the bead connecting the rotation center shaft (pivot shaft R2) of the other end of the first arm 80 and the slider shoe 71X is denoted by a reference sign 75, the bead connecting the rotation center shaft (pivot shaft R2) of the other end of the first arm 80 and the slider shoe 72X is denoted by a reference sign 76, the bead connecting the rotation center shaft (pivot shaft R4) of the other end of the second arm 60 and the slider shoe 71X is denoted by a reference sign 77, the bead connecting the rotation center shaft (pivot shaft R4) of the other end of the second arm 60 and the slider shoe 72X is denoted by a reference sign 78, and the bead connecting the rotation center shaft (pivot shaft R2) of the other end of the first arm 80 and the rotation center shaft (pivot shaft R4) of the other end of the second arm 60 is denoted by a reference sign 79.

The number, shape, type and the like of the beads 75 to 79 illustrated here can be subjected to various design changes. For example, a bead (not illustrated) connecting the two slider shoes 71X and 72X may be added so as to intersect with the bead 79 connecting the rotation center shaft (pivot shaft R2) of the other end of the first arm 80 and the rotation center shaft (pivot shaft R4) of the other end of the second arm 60.

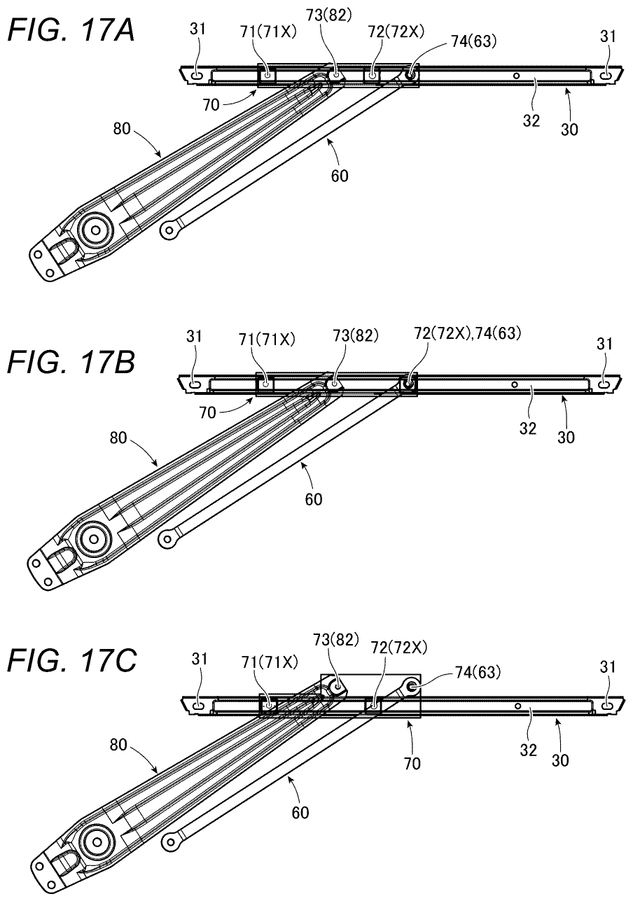

FIGS. 17A, 17B, and 17C are diagrams illustrating the window regulator 1 according to still another embodiment (modification). In the above embodiment, the rotation center shaft (pivot shaft R2) of the other end of the first arm 80 and the rotation center shaft (pivot shaft R4) of the other end of the second arm 60 are positioned between the two slider shoes 71X and 72X in the vehicle front-rear direction. On the other hand, only the rotation center shaft (pivot shaft R2) of the other end of the first arm 50 may be positioned between the two slider shoes 71X and 72X in the vehicle front-rear direction, and the rotation center shaft (pivot shaft R4) of the other end of the second arm 60 may not be positioned between the two slider shoes 71X and 72X. Further, in the above embodiment, the rotation center shaft (pivot shaft R2) of the other end of the first arm 80 and the rotation center shaft (pivot shaft R4) of the other end of the second arm 60 are positioned so as to be shifted to the vehicle upper side or the vehicle lower side with respect to the two slider shoes 71X and 72X in the vehicle up-down direction. Specifically, the rotation center shaft (pivot shaft R2) of the other end of the first arm 80 is shifted to the vehicle upper side with respect to the two slider shoes 71X and 72X in the vehicle up-down direction, and the rotation center shaft (pivot shaft R4) of the other end of the second arm 60 is shifted to the vehicle lower side with respect to the two slider shoes 71X and 72X in the vehicle up-down direction. On the other hand, the rotation center shaft (pivot shaft R2) of the other end of the first arm 80 and the rotation center shaft (pivot shaft R4) of the other end of the second arm 60 may be or may not be shifted in the vehicle up-down direction with respect to the two slider shoes 71X and 72X, and the direction of the shift can also be set with a degree of freedom.

In FIG. 17A, the bell crank 70 is formed in a rectangular shape having a long side in the vehicle front-rear direction and a short side in the vehicle up-down direction. Further, heights of the rotation center shaft (pivot shaft R2) of the other end of the first arm 80 and the rotation center shaft (pivot shaft R4) of the other end of the second arm 60 in the up-down direction are set to be the same as those of the two slider shoes 71X and 72X, the rotation center shaft (pivot shaft R2) of the other end of the first arm 80 is positioned between the two slider shoes 71X and 72X, and the rotation center shaft (pivot shaft R4) of the other end of the second arm 60 is positioned at the rear side the two slider shoes 71X and 72X.

In FIG. 17B, the bell crank 70 is formed in a rectangular shape having a long side in the vehicle front-rear direction and a short side in the vehicle up-down direction. Further, heights of the rotation center shaft (pivot shaft R2) of the other end of the first arm 80 and the rotation center shaft (pivot shaft R4) of the other end of the second arm 60 in the up-down direction are set to be the same as those of the two slider shoes 71X and 72X, the rotation center shaft (pivot shaft R2) of the other end of the first arm 80 is positioned between the two slider shoes 71X and 72X, and the rotation center shaft (pivot shaft R4) of the other end of the second arm 60 is positioned at the same position as the rotation support shaft of the slider shoe 72X (a slide shaft and the pivot shaft are made in common and fastened together).

In FIG. 17C, the bell crank 70 is formed in a rectangular shape having a long side in the vehicle front-rear direction and a short side in the vehicle up-down direction. Further, the rotation center shaft (pivot shaft R2) of the other end of the first arm 80 and the rotation center shaft (pivot shaft R4) of the other end of the second arm 60 are shifted to the vehicle upper side in the up-down direction to be higher than the two slider shoes 71X and 72X, the rotation center shaft (pivot shaft R2) of the other end of the first arm 80 is positioned between the two slider shoes 71X and 72X, and the rotation center shaft (pivot shaft R4) of the other end of the second arm 60 is positioned at the rear side the two slider shoes 71X and 72X.

Although the disclosure according to this disclosure is described in detail above, it is obvious to those skilled in the art that the disclosure according to this disclosure is not limited to the embodiments described in this disclosure. The disclosure according to this disclosure can be modified and changed without departing from the spirit or scope of the disclosure defined based on the claims. Accordingly, the description of this disclosure is intended for illustrative description, and does not limit the disclosure according to this disclosure in any sense.

In the embodiments described above, the window regulator 1 of a power window type is exemplified in which the first arm 50 and the second arm 60 are rotationally driven by the motor unit 20. However, the disclosure is also applicable to a manual (manual type) window regulator that transmits a driving force of manual rotation to the first and second arms. That is, there is a degree of freedom in a specific form of the drive member that rotationally drives the first and second arms (arm members), and various design changes can be made.

In the embodiment described above, a case where the other end portions of the first arm 50 and the second arm 60 are rotatably supported by the bell crank (shoe member) 40 slidably supported by the bracket 30 is described as an example. Alternatively, it is also possible to adopt a mode in which the other end portions of the first and second arms are rotatably supported with respect to a part of the bracket or another support member to the bracket.

In the embodiment described above, a case is described as an example where the other end of the first arm 50 is rotatably supported by the connection portion of the first side portion 41 and the second side portion 42 and the other end of the second arm 60 is rotatably supported by the second side portion 42, and accordingly the rotation support portions of the other ends of the first arm 50 and the second arm 60 are offset in the up-down direction and are (almost) not offset in the front-rear direction. Alternatively, by rotatably supporting the other end of the first arm 50 at the first side portion 41, the rotation support portions of the other ends of the first arm 50 and the second arm 60 may be offset in both the up-down direction and the front-rear direction. However, even in this case, it is preferable that an offset amount in the up-down direction is larger than an offset amount in the front-rear direction.

In the embodiment described above, a case where the one end portions of the first arm 50 and the second arm 60 are rotatably supported by the base 10 is described as an example. Alternatively, the one end portions of the first arm 50 and the second arm 60 may be rotatably supported by a vehicle member other than the base 10, for example, a vehicle member other than the window regulator 1 in an assembly (sub-assembly) state.

The present application is based on Japanese Patent Application No. 2022-139936 filed on Sep. 2, 2022, Japanese Patent Application No. 2022-139937 filed on Sep. 2, 2022, and Japanese Patent Application No. 2022-168910 filed on Oct. 21, 2022. All the contents thereof are incorporated herein.

### Reference Signs List

1: window regulator

10: base (base plate, vehicle member constituting door)

11: insertion hole

12: fitting hole

13: insertion hole

13X: fastening member

14: pivot support hole

15: pivot support hole

16: sidewall portion

17: second support flat portion

18: first support flat portion

20: motor unit (drive member)

30: bracket (lift arm bracket)

31: insertion hole

32: slide rail

40: bell crank (shoe member)

41: first side portion

42: second side portion

43: through hole

43X: slider shoe

44: through hole (pivot support hole)

45: through hole (pivot support hole)

45X: slider shoe

50: first arm (main arm, lift arm, arm member)

51: pivot support hole

52: pivot support hole

53: driven gear (gear member)

53X: teeth (gear mechanism)

60: second arm (sub-arm, EQ rod, arm member)

61: narrow portion

62: wide portion

63: pivot support hole

64: pivot support hole

70: bell crank (bracket)

71: sliding support hole

71X: slider shoe (shoe member)

72: sliding support hole

72X: slider shoe (shoe member)

73: pivot support hole

74: pivot support hole

75: bead

76: bead

77: bead

78 bead

79: bead

80: first arm (main arm, lift arm, arm member)

81: pivot support hole

82: pivot support hole

83: driven gear (gear member)

83X: teeth (gear mechanism)

84: central bead

85: peripheral flange

P1: pivot support pin

P2: pivot support pin

P3: pivot support pin

R1: pivot shaft

R2: pivot shaft

R3: pivot shaft

R4: pivot shaft

W: window glass

1. A window regulator comprising:
a bracket on which window glass is to be supported;
a first arm one end of which is rotatably supported by a vehicle member constituting a door and the other end of which is rotatably supported by the bracket;
a second arm one end of which is rotatably supported by the vehicle member and the other end of which is rotatably supported by the bracket; and
a drive member configured to drive the bracket, on which the window glass is to be supported, by rotationally driving the first arm and the second arm, wherein
a rotation center shaft of the one end of the first arm and a rotation center shaft of the one end of the second arm are shifted in a drive direction of the bracket on which the window glass is to be supported, and
a rotation center shaft of the other end of the first arm and a rotation center shaft of the other end of the second arm are shifted in the drive direction of the bracket on which the window glass is to be supported.

2. The window regulator according to claim 1, wherein
the first arm and the second arm at least partially overlap each other as viewed in a vehicle up-down direction.

3. The window regulator according to claim 1, wherein
the bracket includes a shoe member slidable in an extending direction of a slide rail of the bracket,
the other end of the first arm and the other end of the second arm are rotatably supported by the shoe member so as to be shifted in the drive direction of the bracket on which the window glass is to be supported,
the shoe member includes a first side portion extending in an extending direction of the bracket and a second side portion bent from the first side portion in a direction intersecting the extending direction of the bracket,
the other end of the first arm is rotatably supported by the first side portion or by a connection portion of the first side portion and the second side portion, and
the other end of the second arm is rotatably supported by the second side portion.

4. The window regulator according to claim 1, wherein
in a movable range of the first arm, a line segment connecting a rotation center of the one end and a rotation center of the other end of the first arm does not overlap a rotation center of the one end or a rotation center of the other end of the second arm.

5. The window regulator according to claim 1, wherein
when the window glass is positioned at a bottom dead center, a shift amount in the drive direction between a rotation support portion of the one end of the first arm and a rotation support portion of the one end of the second arm and a shift amount in the drive direction between a rotation support portion of the other end of the first arm and a rotation support portion of the other end of the second arm are smaller than a distance between a rotation center of the other end of the first arm and a lower surface of a vehicle door panel.

6. The window regulator according to claim 1, wherein
a width of the first arm is larger than a width of the second arm.

7. The window regulator according to claim 1, wherein
the one end of the first arm and the one end of the second arm are rotatably supported by the vehicle member so as to be shifted in the drive direction of the bracket, on which the window glass is to be supported, and a vehicle width direction.

8. The window regulator according to claim 1, wherein
the vehicle member is a base to be assembled to an inner panel or an outer panel of a vehicle, and
the drive member drives the bracket, on which the window glass is to be supported, by rotationally driving the first arm with respect to the base and the bracket and rotationally driving the second arm with respect to the base and the bracket.

9. The window regulator according to claim 8, wherein
the base is formed of a single member.

10. The window regulator according to claim 8, wherein
the first arm and the second arm at least partially overlap each other as viewed in a vehicle up-down direction.

11. The window regulator according to claim 8, wherein
the base includes a pair of sidewall portions extending in a vehicle width direction and a second support flat portion connected to the pair of sidewall portions, and
the one end of the second arm is rotatably supported by the second support flat portion of the base.

12. The window regulator according to claim 11, wherein
the base includes a first support flat portion by which the one end of the first arm is rotatably supported and the second support flat portion by which the one end of the second arm is rotatably supported, and
the first arm the one end of which is supported by the first support flat portion and the second arm the one end of which is supported by the second support flat portion are offset in the vehicle width direction.

13. The window regulator according to claim 8, wherein
the second arm includes a narrow portion positioned intermediate between the one end and the other end, and a wide portion positioned at the one end and rotatably supported by the base.

14. The window regulator according to claim 1, wherein
the bracket includes two shoe members spaced apart from each other in a vehicle front-rear direction, and
the rotation center shaft of the other end of the first arm and the rotation center shaft of the other end of the second arm are positioned between the two shoe members in the vehicle front-rear direction.

15. The window regulator according to claim 14, wherein
the bracket includes a bead positioned between the two shoe members and the rotation center shafts of the other ends of the first arm and the second arm.

16. The window regulator according to claim 14, wherein
the rotation center shafts of the other ends of the first arm and the second arm are shifted to a vehicle upper side or a vehicle lower side with respect to the two shoe members in a vehicle up-down direction.

17. The window regulator according to claim 1, wherein
when the first arm and the second arm extend in a first direction and the window glass rotates in the first direction about the other end of the first arm, the second arm is disposed above the first arm,
when the first arm and the second arm extend in the first direction and the window glass rotates in a second direction about the other end of the first arm, the second arm is disposed below the first arm, and
the first direction and the second direction are opposite to each other.
